(19) United States
(12) Patent Application Publication
(10) Pub. No.: US 2015/0370122 A1
(43) Pub. Date: Dec. 24, 2015

(54) DISPLAY

(71) Applicants: Kuo-Teng Hsu, Hsinchu (TW); Chih-Tsung Lu, Hsinchu (TW); Tse-Hung Hsiao, Hsinchu (TW); Yi-Chang Lin, Hsinchu (TW); Chia-Feng Chen, Hsinchu (TW); Lie-Zen Chung, Hsinchu (TW)

(72) Inventors: Kuo-Teng Hsu, Hsinchu (TW); Chih-Tsung Lu, Hsinchu (TW); Tse-Hung Hsiao, Hsinchu (TW); Yi-Chang Lin, Hsinchu (TW); Chia-Feng Chen, Hsinchu (TW); Lie-Zen Chung, Hsinchu (TW)

(73) Assignee: KOATECH TECHNOLOGY CORPORATION, Hsinchu Hsien (TW)

(21) Appl. No.: 14/494,605

(22) Filed: Sep. 24, 2014

(30) Foreign Application Priority Data
Jun. 20, 2014 (TW) 103210994

(51) Int. Cl. G02F 1/1335; G09G 3/36; G06F 3/041; G02F 1/1333; G02B 1/14

(52) U.S. Cl. CPC G02F 1/133514; G02F 1/133603; G02F 1/13338; G02B 1/14; G06F 3/0412; G09G 3/36; G06F 2203/04101

(57) ABSTRACT

A display including a backlight module, a liquid crystal module, and a first adhesive layer is provided. The backlight module includes a light source and a plurality of first optical films. The first optical films are stacked on the light source, and at least one first optical film has a hard-coat film layer. The liquid crystal module is disposed on the backlight module. The liquid crystal module includes a liquid crystal element, a plurality of first adhesive layers, and a plurality of second optical films. The second optical films are respectively disposed on two opposite surfaces of the liquid crystal element, wherein at least one second optical film has a hard-coat film layer. Each first adhesive layer is disposed between a second optical film and the liquid crystal element.

### CROSS-REFERENCE TO RELATED APPLICATION

This application claims the priority benefit of Taiwan application serial no. 103210994, filed on Jun. 20, 2014. The entirety of the above-mentioned patent application is hereby incorporated by reference herein and made a part of this specification.

### BACKGROUND OF THE INVENTION

1. Field of the Invention

The invention relates to a display.

2. Description of Related Art

Current electronic products generally adapt a light-emitting diode having high brightness as the backlight such that the screen can have high brightness. However, the light emitted by the light-emitting diode contains a component having a wavelength range of 380 nm to 420 nm. The light having a wavelength range of 380 nm to 420 nm can penetrate the lens of the eye and directly reach the macula of the retina and cause epithelial cells on retinal pigments to degrade. As a result, photosensitive cell death occurs such that the macula is degenerated and vision is decreased, even causing loss of vision.

To reduce damage to the eyes by the light having a wavelength range of 380 nm to 420 nm, a film layer structure to be attached to the screen of electronic products has been developed. When the film layer structure is attached to the screen of electronic products, the film layer structure can filter out light having a specific wavelength range (such as 380 nm to 420 nm) to reduce damage to the eyes by the light emitted from the screen. However, in the known techniques, some film layer structures are formed by numerous film layers, thus causing excessive thickness of the film layer structures. As a result, when the film layer structures are attached to a screen, the exterior of the electronic product is adversely affected. Moreover, although the visible light transmittance of some film layer structures for a wavelength range of 400 nm to 700 nm is high, the light blocking rate thereof for a wavelength range of 380 nm to 420 nm is low. As a result, the eyes of a user using the electronic product cannot be comprehensively protected. Moreover, all of the above require a relevant film layer structure on the outside of the existing display device, thus causing inconvenience for the user in terms of usage and costs.

### SUMMARY OF THE INVENTION

The invention provides a display. At least a portion of the constituent components of the display can achieve the effect of eye protection for a user.

A display of the invention includes a backlight module, a liquid crystal module, and a plurality of first adhesive layers. The backlight module includes a light source and a plurality of first optical films. The first optical films are stacked on the light source, wherein at least one first optical film has a hard-coat film layer. The liquid crystal module includes a liquid crystal element and a plurality of second optical films. The second optical films are respectively disposed on two opposite surfaces of the liquid crystal element, wherein at least one second optical film has a hard-coat film layer. The first adhesive layers are disposed between the second optical films and the liquid crystal element. The light source provides a light emitted from the display through the first optical films, the first adhesive layers, the liquid crystal element, and the second optical films, and the hard-coat film layers and the first adhesive layers filter out a portion of the light.

In an embodiment of the invention, a touch module is further included, wherein the touch module is disposed on one side of the liquid crystal module away from the backlight module. The touch module includes a touch element, a cover glass, and a second adhesive layer. The touch element is disposed on the liquid crystal module. The cover glass is disposed on one side of the touch element away from the liquid crystal module. The second adhesive layer is disposed between the touch element and the cover glass. The light provided by the light source is further emitted from the display through the touch module, and the second adhesive layer filters out a portion of the light.

In an embodiment of the invention, the first adhesive layers and the second adhesive layer respectively include a colloid and a plurality of filter compounds dispersed in the colloid, and the colloid includes an acrylic polymer, a fatty acid ester-based plasticizer, and a hardening agent. The filter compounds include benzophenone, a derivative of benzophenone, phenylazophenyl, a derivative of phenylazophenyl, benzotriazole, a derivative of benzotriazole, or a combination thereof. The filtration rate of the filter compounds for a light having a wavelength range of 380 nm to 495 nm is greater than or equal to 30%.

In an embodiment of the invention, the filtration rate of the filter compounds for a light having a wavelength range of 400 nm to 500 nm is greater than or equal to 20%.

In an embodiment of the invention, the adhesion of the first adhesive layers and the second adhesive layer is respectively greater than or equal to 500 g/25 mm.

In an embodiment of the invention, the thickness of the first adhesive layers is 25 μm to 350 μm.

In an embodiment of the invention, the thickness of the second adhesive layer is 25 μm to 250 μm.

In an embodiment of the invention, the touch module further includes an ink layer disposed between the touch element and the cover glass and forming a step space therebetween. The second adhesive layer is filled in the step space.

In an embodiment of the invention, the hard-coat film layers include a film layer body and a plurality of filter compounds dispersed in the film layer body, the film layer body includes a multifunctional prepolymer, a photocurable initiator, a diluting agent, and a solvent, and an optical particle such as silicon dioxide, silicone, poly(methyl methacrylate), or polystyrene. The filter compounds include benzophenone, a derivative of benzophenone, phenylazophenyl, a derivative of phenylazophenyl, benzotriazole, a derivative of benzotriazole, or a combination thereof. The filtration rate of the filter compounds for a light having a wavelength range of 380 nm to 495 nm is greater than or equal to 30%.

In an embodiment of the invention, the filtration rate of the filter compounds for a light having a wavelength range of 400 nm to 500 nm is greater than or equal to 20%.

In an embodiment of the invention, the thickness of the hard-coat film layers is 1 μm to 50 μm.

In an embodiment of the invention, the haze of the hard-coat film layers is 0% to 90%.

In an embodiment of the invention, the light transmittance of the hard-coat film layers is 50% to 95%.

In an embodiment of the invention, the display further includes a cover glass, another first adhesive layer, and an explosion-proof film. The other first adhesive layer is disposed between the cover glass and the liquid crystal module. The explosion-proof film is disposed on one side of the cover glass opposite to the other first adhesive layer. The other first adhesive layer and the explosion-proof film filter out a portion of the light provided by the light source.

In an embodiment of the invention, the thickness of the other first adhesive layer is 25 μm to 75 μm.

In an embodiment of the invention, the display further includes an explosion-proof film disposed on one side of the cover glass opposite to the second adhesive layer. The explosion-proof film filters out a portion of the light provided by the light source.

Based on the above, in the display of the invention, since the hard-coat film layers are disposed on the first optical film and the second optical film, and the first adhesive layers are disposed in the liquid crystal module, when the light generated by the light source is emitted from the display, the effect of filtration of a portion of the light can be achieved by the above structure. As a result, a user can avoid looking directly at a portion of the light harmful to the eyes, thereby achieving the effect of eye protection for the user.

In order to make the aforementioned and other features and advantages of the invention more comprehensible, several embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of the assembly of a display according to an embodiment of the invention.

FIG. 2 is an enlarged schematic diagram of a portion of a touch module in the display of FIG. 1.

FIG. 3 illustrates a spectral schematic diagram of the display of FIG. 1.

FIG. 4 is a schematic diagram of the assembly of a display according to another embodiment of the invention.

### DESCRIPTION OF THE EMBODIMENTS

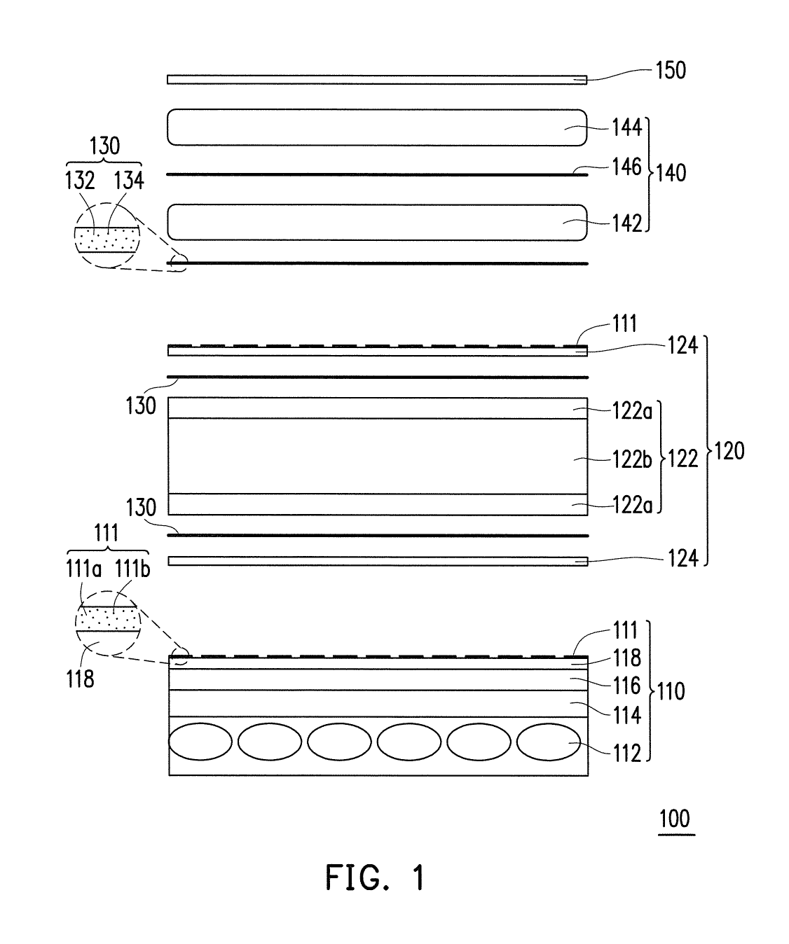

FIG. 1 is a schematic diagram of the assembly of a display according to an embodiment of the invention. Referring to FIG. 1, in the present embodiment, a display 100 is, for instance, a touch-type display. The display 100 includes a backlight module 110, a liquid crystal module 120, a plurality of first adhesive layers 130, and a touch module 140. The backlight module 110 includes a light source 112 and a plurality of first optical films 114, 116, and 118 stacked on the light source 112, wherein at least one of the first optical films 114, 116, and 118 has a hard-coat film layer 111 (i.e. hard-coated film). Here, the light source 112 is, for instance, formed by a plurality of light-emitting diodes, but the invention is not limited thereto. The first optical films 114, 116, and 118 are respectively a light guide plate, a prism sheet, and a diffuser sheet, or the first optical films 114, 116, and 118 are a light guide plate, a diffuser sheet, and a prism sheet so as to perform further treatments on the light generated by the light source 112. In particular, the diffuser sheet is used to provide a surface light source having uniform brightness after receiving the irradiation of the light source 112, the light guide plate guides the light toward the liquid crystal module 120 through a microstructure thereof, and the prism sheet concentrates the light to a specific range of the liquid crystal module 120 through a micro-prism structure thereon. It should first be mentioned that, although in FIG. 1, the hard-coat film layer 111 is only disposed on the first optical film 118, the present embodiment is not limited thereto. That is, the hard-coat film layer 111 can also be disposed on the other first optical films 114 and 116 as needed.

Moreover, the liquid crystal module 120 is disposed on the backlight module 110, and the liquid crystal module 120 includes a liquid crystal element 122 and a plurality of second optical films 124, wherein the liquid crystal element 122 is, for instance, formed by injecting a liquid crystal layer 122b between two glass substrates 122a, and the second optical films 124 are, for instance, polarizing films respectively disposed on two opposite surfaces of the liquid crystal element 122, the phase of the polarizing films 124 located on different sides is different, and at least one second optical film 124 has the hard-coat film layer 111. The first adhesive layers 130 are disposed between the liquid crystal element 122 and the second optical films 124 of the liquid crystal module 120 as interface layers combining the two. Moreover, similarly to the above, although in FIG. 1, the hard-coat film layer 111 is only illustrated for the second optical film 124 located above the liquid crystal element 122, the hard-coat film layer 111 can also be disposed on the other second optical films 124 according to actual product demand.

Moreover, the touch module 140 is disposed on one side of the liquid crystal module 120 away from the backlight module 110, and the touch module 140 includes a touch element 142, a cover glass 144, and a second adhesive layer 146, wherein the touch element 142 is combined onto the second optical films 124 of the liquid crystal module 120 through another first adhesive layer 130, the cover glass 144 is disposed on one side of the touch element 142 away from the liquid crystal module 120, and the second adhesive layer 146 is disposed between the touch element 142 and the cover glass 144 as an interface layer combining and fixing the touch element 142 and the cover glass 144.

In the present embodiment, in FIG. 1, a first adhesive layer 130 and a hard-coat film layer 111 are respectively partially enlarged, and the structure of the second adhesive layer 146 is the same as the first adhesive layer 130. Therefore, only the first adhesive layer 130 is exemplified and the second adhesive layer 146 is not described (but is labeled in other figures). It should be mentioned here that, in the structure of the display 100, the first adhesive layers 130, the second adhesive layer 146, and the hard-coat film layers 111 all have a plurality of filter compounds 111b and 134 dispersed therein such that the effect of filtration of a portion of the light generated by the light source 112 can be provided. Each component is further described below.

In the present embodiment, the thickness of the first adhesive layers 130 located in the liquid crystal module 120 is 25 μm to 350 μm, the thickness of the first adhesive layer 130 located between the touch module 140 and the liquid crystal module 120 is 25 μm to 350 μm, and the adhesion of the two is respectively greater than or equal to 500 g/25 mm, and the first adhesive layers 130 include a colloid 132 and a plurality of filter compounds 134 dispersed in the colloid 132. The uncured colloid 132 includes an acrylic polymer, an aliphatic acid ester-based plasticizer, and a hardening agent, and the viscosity of the uncured colloid 132 is, for instance, between 1 cP and 10,000 cPs, more particularly 500 cPs to 5,000 cPs. The structural formula of the acrylic polymer is as follows:

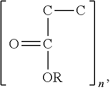

wherein R can be, for instance, a methyl group, an ethyl group, a butyl group, or a hydrocarbon group.
The structural formula of the fatty acid ester-based plasticizer of the colloid 132 is as follows: (R—COOR′), wherein R can be 12 to 18 carbon alkyl groups, and R′ can be, for instance, a methane group or an ethane group.
The structural formula of the hardening agent of the colloid 132 is as follows:

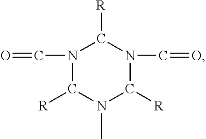

wherein R can be an aromatic compound or an aliphatic compound.

In the present embodiment, the filter compounds 134 are specially designed compounds, and the filter compounds 134 can effectively filter out the component of the light having a specific wavelength range (i.e., 380 nm to 420 nm). The filtration rate of the filter compounds 134 for light having a wavelength range of 380 nm to 495 nm is greater than or equal to 30%. More particularly, the filtration rate of the filter compounds 134 for light having a wavelength range of 400 nm to 500 nm is greater than or equal to 20%.

For instance, the filter compounds 134 of the present embodiment include benzophenone, a derivative of benzophenone, phenylazophenyl, a derivative of phenylazophenyl, benzotriazole, a derivative of benzotriazole, or a combination thereof. The chemical structural formula of the benzophenone is as follows:

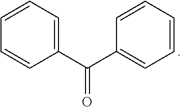 [SMILES: O=C(c1ccccc1)c1ccccc1]

The chemical structural formula of the phenylazophenyl is as follows:

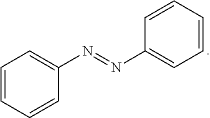 [SMILES: c1ccc(/N=N/c2ccccc2)cc1]

The chemical structural formula of the benzotriazole is as follows:

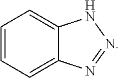

Moreover, the hard-coat film layers 111 of the present embodiment are formed by a film layer body 111a and a plurality of filter compounds 111b dispersed therein. The thickness of the hard-coat film layers 111 is 1 μm to 50 μm, the haze thereof is 0% to 90%, and the light transmittance thereof is 50% to 95%. The film layer body 111a includes a multifunctional prepolymer, a photocurable initiator, a diluting agent, and a solvent, and an optical particle such as silicon dioxide, silicone, poly(methyl methacrylate), or polystyrene. Here, the multifunctional prepolymer can be 3 to 6 multifunctional polyurethane prepolymers. The solid content of the 3 to 6 multifunctional polyurethane prepolymers account for 20% to 80% of the overall solid content of the hard-coat film layers 111, more particularly 30% to 60%. Moreover, the functional group of the multifunctional prepolymer is an acrylic functional group, and the multifunctional prepolymer having the acrylic functional group is a non-yellowing polyurethane prepolymer. The diluting agent is an acrylic monomer having a reactive functional group. The solvent is, for instance, a ketone or an ester, and is used to adjust the viscosity and coating characteristics of the uncured film layer body 111a. Moreover, the filter compounds 111b are the same as the filter compounds 134, wherein features and effects of the filter compounds 111b are as described in the above embodiments and are therefore not repeated herein.

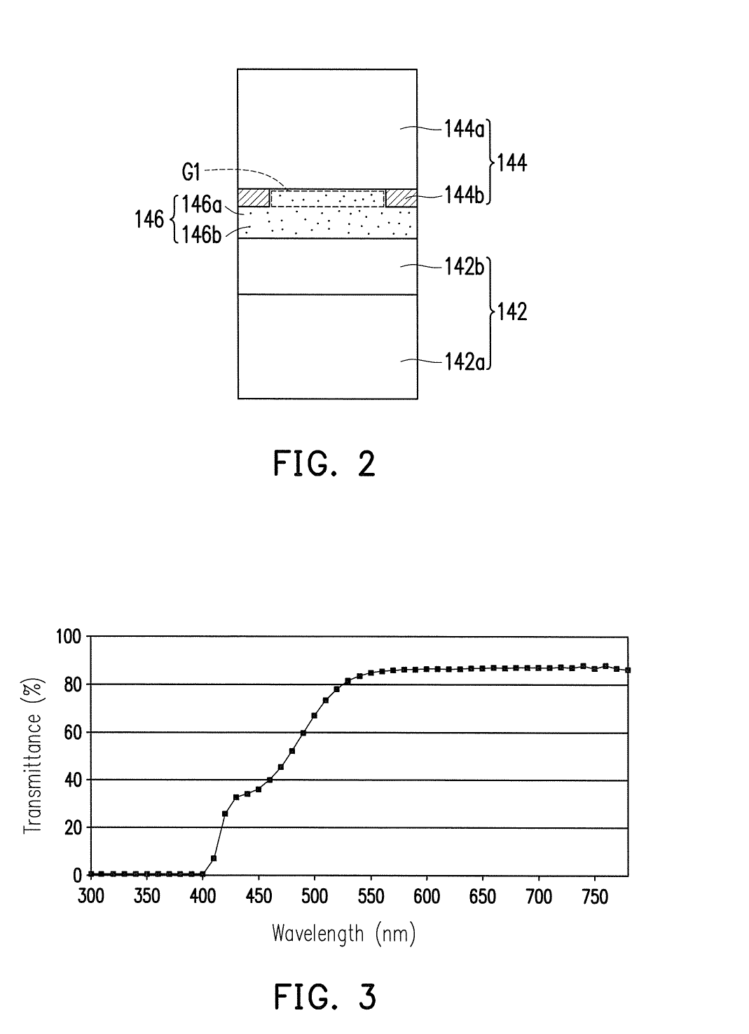

FIG. 2 is an enlarged schematic diagram of a portion of a touch module in the display of FIG. 1. Referring to FIG. 1 and FIG. 2, in the present embodiment, the cover glass 144 contains a substrate 144a and an ink layer 144b disposed on the substrate 144a, and the ink layer 144b is stepped relative to the substrate 144a. Moreover, the touch element 142 is formed by a substrate 142a and a touch-sensitive layer 142b disposed thereon. Accordingly, when the touch element 142 and the cover glass 144 are combined, a step space G1 is generated due to the presence of the ink layer between the touch-sensitive layer 142b and the substrate 144a. However, in the present embodiment, since the second adhesive layer 146 is disposed between the substrate 144a and the touch-sensitive layer 142b, the second adhesive layer 146 can be filled in the step space G1. As a result, the generation of air bubbles during the combination process of the touch element 142 and the cover glass 144 can be prevented. Moreover, the second adhesive layer 146 is formed by a colloid 146a and a plurality of filter compounds 146b dispersed therein, wherein the thickness of the second adhesive layer 146 is 25 μm to 250 μm and the adhesion thereof is greater than or equal to 500 g/25 mm. Moreover, the structural composition of the second adhesive layer 146 is the same as that of the first adhesive layers 130 and is therefore not repeated herein.

Moreover, further referring to FIG. 1, in the present embodiment, the display 100 also includes an explosion-proof film 150 disposed on one side of the cover glass 144 opposite to the second adhesive layer 146, and the explosion-proof film 150 has a plurality of filter compounds (same as the filter compounds in the above embodiments and are therefore not illustrated here) dispersed therein. As a result, the explosion-proof film 150 can also provide the effect of filtration of a portion of a specific light (as described above) to the display 100.

Moreover, the liquid crystal module 120 of the display 100 also includes a plurality of first adhesive layers 130 respectively used to join the second optical films 124 and the liquid crystal element 122. In other words, the components in the present embodiment can all be combined by adhesive layers having filter compounds.

Based on the above, since the first adhesive layers 130 and the second adhesive layer 146 are disposed in the display 100, the hard-coat film layers 111 are disposed on the optical films, and filter compounds are dispersed in the display 100, the effect of filtration of a portion of a light generated by the light source 112 having a specific wavelength can be provided. FIG. 3 illustrates a spectral schematic diagram of the display of FIG. 1, and it is apparent from the figure that the wave band of the final light emitted from the display 100 that may cause damage to the human eye is filtered out.

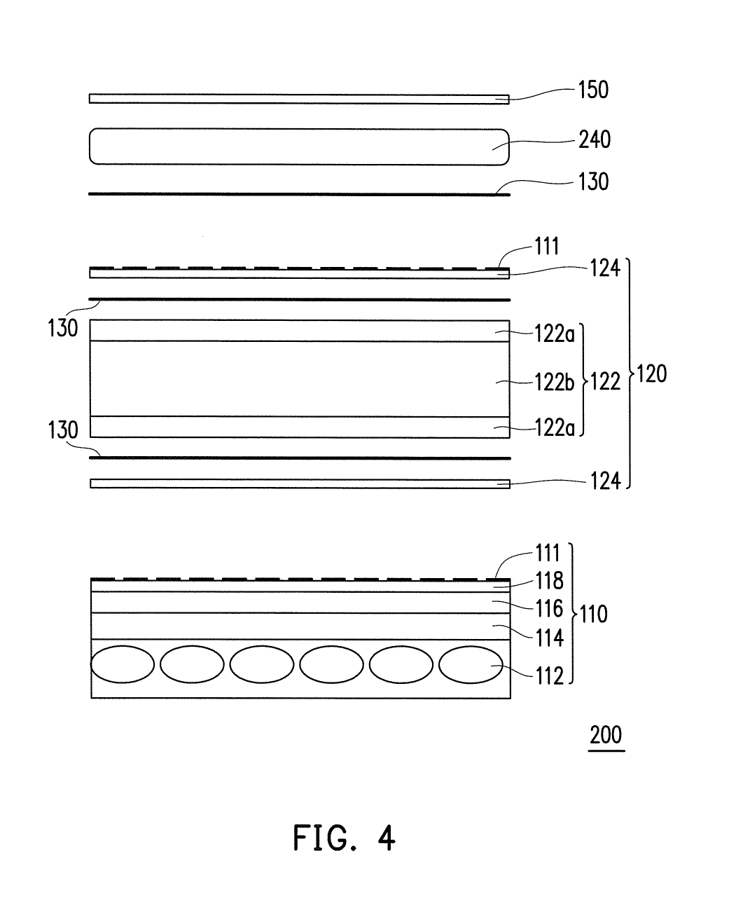

FIG. 4 is a schematic diagram of the assembly of a display according to another embodiment of the invention. In the present embodiment, a display 200 is an ordinary liquid crystal display device and does not have the touch module 140 of the embodiment of FIG. 1. Accordingly, only a cover glass 240 and the explosion-proof film 150 are disposed above the liquid crystal module, and the two are combined with the liquid crystal module 120 by a first adhesive layer 130. Here, the features of relevant structures of the backlight module and the liquid crystal module are as shown in FIG. 1, and the first adhesive layers 130 and the explosion-proof film 150 are also as described in the above embodiments, and are therefore not repeated herein.

Based on the above, in the above embodiments of the invention, since the hard-coat film layers are disposed on the first optical film and the second optical film, and the first adhesive layers are disposed in the liquid crystal module, when the light generated by the light source is emitted from the display, the effect of filtration of a portion of the light can be achieved by the above structure. As a result, a user can avoid looking directly at a portion of the light harmful to the eyes, that is, the light having a wavelength range of 380 nm to 500 nm, thereby achieving the effect of eye protection for the user.

Moreover, in the touch module of the display of the present application, the second adhesive layer disposed between the touch element and the cover glass is not only used to join components, but can also compensate for the step between the touch element and the cover glass. Moreover, the second adhesive layer can further generate a similar light filtration effect to the first adhesive layers through the plurality of filter compounds dispersed in the film layer body thereof. Therefore, based on the above, since adhesive layers for adhering components and hard-coat film layers on optical films are used in the display of the present application such that both the adhesive layers and the hard-coat film layers have filter compounds having the effect of light filtration, the display can filter out light harmful to the human eye and thereby provide sufficient protective effect.

Although the invention has been described with reference to the embodiments thereof, it will be apparent to one of the ordinary skills in the art that modifications to the described embodiments may be made without departing from the spirit of the invention. Accordingly, the scope of the invention will be defined by the attached claims not by the above detailed description.

What is claimed is:

1. A display, comprising:
a backlight module, comprising:
a light source;
a plurality of first optical films stacked on the light source, wherein at least one first optical film has a hard-coat film layer;
a liquid crystal module disposed on the backlight module, the liquid crystal module comprising:
a liquid crystal element;
a plurality of second optical films respectively disposed on two opposite surfaces of the liquid crystal element, wherein at least one second optical film has another hard-coat film layer; and
a plurality of first adhesive layers respectively disposed between the second optical films and the liquid crystal element, wherein the light source provides a light emitted from the display through the first optical films, the first adhesive layers, the liquid crystal element, and the second optical films, and the hard-coat film layers and the first adhesive layers filter out a portion of the light.

2. The display of claim 1, further comprising:
a touch module disposed on one side of the liquid crystal module away from the backlight module, the touch module comprising:
a touch element disposed on the liquid crystal module;
a cover glass disposed on one side of the touch element away from the liquid crystal module; and
a second adhesive layer disposed between the touch element and the cover glass, wherein the light provided by the light source is further emitted from the display through the touch module, and the second adhesive layer filters out a portion of the light.

3. The display of claim 2, wherein the first adhesive layer and the second adhesive layer respectively comprise a colloid and a plurality of filter compounds dispersed in the colloid, the colloid comprises an acrylic polymer, a fatty acid ester-based plasticizer, and a hardening agent, the filter compounds comprise benzophenone, a derivative of benzophenone, phenylazophenyl, a derivative of phenylazophenyl, benzotriazole, a derivative of benzotriazole, or a combination thereof, and a filtration rate of the filter compounds for a light having a wavelength range of 380 nm to 495 nm is greater than or equal to 30%.

4. The display of claim 3, wherein a filtration rate of the filter compounds for a light having a wavelength range of 400 nm to 500 nm is greater than or equal to 20%.

5. The display of claim 2, wherein an adhesion of the first adhesive layers and the second adhesive layer is respectively greater than or equal to 500 g/25 mm.

6. The display of claim 2, wherein a thickness of the first adhesive layers is 25 μm to 350 μm.

7. The display of claim 2, wherein a thickness of the second adhesive layer is 25 μm to 250 μm.

8. The display of claim 2, wherein the touch module further comprises:
an ink layer disposed between the touch element and the cover glass and forming a step space therebetween, and the second adhesive layer is filled in the step space.

9. The display of claim 1, wherein the hard-coat film layers comprise a film layer body and a plurality of filter compounds dispersed in the film layer body, the film layer body comprises a multifunctional prepolymer, a photocurable initiator, a diluting agent, and a solvent, and an optical particle such as silicon dioxide, silicone, poly(methyl methacrylate), and polystyrene, the filter compounds comprise benzophenone, a derivative of benzophenone, phenylazophenyl, a derivative of phenylazophenyl, benzotriazole, a derivative of benzotriazole, or a combination thereof, and a filtration rate of the filter compounds for a light having a wavelength range of 380 nm to 495 nm is greater than or equal to 30%.

10. The display of claim 9, wherein a filtration rate of the filter compounds for a light having a wavelength range of 400 nm to 500 nm is greater than or equal to 20%.

11. The display of claim 1, wherein a thickness of the hard-coat film layers is 1 μm to 50 μm.

12. The display of claim 1, wherein a haze of the hard-coat film layers is 0% to 90%.

13. The display of claim 1, wherein a light transmittance of the hard-coat film layers is 50% to 95%.

14. The display of claim 1, further comprising:
a cover glass and another first adhesive layer, wherein the other first adhesive layer is disposed between the cover glass and the liquid crystal module; and
an explosion-proof film disposed on one side of the cover glass opposite to the other first adhesive layer, wherein the other first adhesive layer and the explosion-proof film filter out a portion of the light provided by the light source.

15. The display of claim 14, wherein a thickness of the other first adhesive layer is 25 μm to 75 μm.

16. The display of claim 2, further comprising:
an explosion-proof film disposed on one side of the cover glass opposite to the second adhesive layer, wherein the explosion-proof film filters out a portion of the light provided by the light source.
